(19) United States
(12) Patent Application Publication
(10) Pub. No.: US 2008/0292421 A1
(43) Pub. Date: Nov. 27, 2008

(54) Self-drilling wall anchor device

(76) Inventor: Chin Hou Lin, Nantou (TW)

Correspondence Address: CHARLES E. BAXLEY, ESQUIRE, 90 JOHN STREET, SUITE 309, NEW YORK, NY, 10038, US

(21) Appl. No.: 11/999,588

(22) Filed: Dec. 6, 2007

Related U.S. Application Data
(63) Continuation-in-part of application No. 11/805,149, filed on May 22, 2007.

(51) Int. Cl. F16B 13/06

(52) U.S. Cl. 411/30

(57) ABSTRACT

A wall anchor device includes an outer anchor sleeve having an outer peripheral lip, one or more peripheral flanges extended outwardly from the middle portion for engaging with a work piece, an insert engageable into the outer anchor sleeve and having an outer end for being driven by a tool, and a penetrating element attached to the insert to drill and move the anchor sleeve into the wall, the outer anchor sleeve may be expanded and engaged with the work piece, and the penetrating element includes one or more projections for centering the penetrating element relative to the work piece and for removing the drilled materials from or out of the work pieces.

The present invention is a continuation-in-part of U.S. patent application Ser. No. 11/805,149, filed 22 May 2007, pending.

### BACKGROUND OF THE INVENTION

1. Field of the Invention

The present invention relates to a wall anchor device, and more particularly to a self-drilling wall anchor device having a centering or stabilizing device for centering or stabilizing the drilling operation of the wall anchor device and for preventing the wall anchor device from being tilted relative to the work piece.

2. Description of the Prior Art

Various kinds of typical wall anchor devices have been developed, and comprise a drilling cap or drilling head for engaging into the work pieces and for engaging a fastener into the wall members and for securing the wall anchor devices to the wall members or the like.

For example, U.S. Pat. No. 4,629,380 to Gunkel et al. discloses one of the typical wall anchor devices which comprises a mandrel portion engaged into a sleeve, and a drilling cap or drilling head attached to one end of the mandrel portion for engaging into the work pieces and for securing the wall anchor devices to the wall members or the like.

However, the drilling cap or drilling head may not be suitably centered or stabilized when the drilling cap or drilling head is engaged into a deep hole or cavity.

U.S. Pat. No. 5,147,166 to Harker discloses a further typical wall anchor device comprising a threaded bolt threaded in an expansible body element, to expand the expansible body element and thus to engage and secure the wall anchor devices to wall members or the like, and a penetrating element attached to one end of the threaded bolt for engaging into the work pieces and for securing the wall anchor devices to the wall members or the like.

However, similarly, the penetrating element may not be suitably centered or stabilized when the penetrating element is engaged into a deep hole or cavity.

U.S. Pat. No. 5,690,454 to Smith discloses a still further typical wall anchor device which comprises a threaded bolt threaded in an expansible anchor, and rotatable or drivable by a driving tool to expand the expansible anchor and thus to engage and secure the wall anchor devices to wall members or the like.

However, the threaded bolt may not be attached with a drilling cap or drilling head or a penetrating element and thus may not be used for engaging into the work pieces and for securing the wall anchor devices to the wall members or the like.

The present invention has arisen to mitigate and/or obviate the afore-described disadvantages of the conventional wall anchor devices.

### SUMMARY OF THE INVENTION

The primary objective of the present invention is to provide a self-drilling wall anchor device including a centering or stabilizing device for centering or stabilizing the drilling operation of the wall anchor device and for preventing the wall anchor device from being tilted relative to the work piece.

The other objective of the present invention is to provide a self-drilling wall anchor device including a centering or stabilizing device for removing the drilled materials from or out of the work piece.

In accordance with one aspect of the invention, there is provided a wall anchor device for engaging and anchoring into a work piece which includes a cavity formed therein, the wall anchor device comprising an outer anchor sleeve including an outer end portion, an expandable middle portion, and an inner end portion, the outer anchor sleeve including a bore formed therein, an insert engageable into the bore of the outer anchor sleeve and including an outer end having an engaging hole formed therein for engaging with a tool device, and for allowing the insert to be rotated and driven by the tool device, the insert including an outer thread formed thereon, and including an inner end portion, a penetrating element attached to the inner end portion of the insert to allow the penetrating element to be rotated and driven by the insert, and at least one projection extended radially and outwardly from the penetrating element for engaging with the work piece and for centering the penetrating element relative to the work piece and for preventing the penetrating element from being tilted relative to the work piece, and the penetrating element is rotatable by the tool device with the insert for drilling into the work piece, and for engaging the outer anchor sleeve into the work piece, and the projection of the penetrating element removing a drilled material from the work piece.

The outer anchor sleeve includes at least one longitudinal slot formed in the middle portion thereof to facilitate bending of the middle portion of the outer anchor sleeve. The insert including a secondary outer thread formed thereon, and the penetrating element includes an inner thread formed therein for threading and engaging with the secondary outer thread of the insert.

The projection is preferably, but not necessarily inclined relative to the penetrating element. The outer anchor sleeve includes at least one peripheral flange extended outwardly therefrom for engaging with the work piece and for anchoring the outer anchor sleeve to the work piece. The peripheral flange of the outer anchor sleeve is a helical flange.

The outer anchor sleeve includes a peripheral lip extended radially and outwardly from the outer end portion of the outer anchor sleeve for engaging with the work piece.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial cross sectional view illustrating the operation of a self-drilling wall anchor device in accordance with the present invention;

FIG. 2 is an enlarged partial cross sectional view of the self-drilling wall anchor device;

FIG. 3 is an exploded view of the self-drilling wall anchor device;

FIG. 4 is a partial cross sectional view of the self-drilling wall anchor device; and

FIGS. 5, 6, 7 are partial cross sectional views similar to FIG. 1 illustrating the operation of a self-drilling wall anchor device.

### DETAILED DESCRIPTION OF THE PREFERRED EMBODIMENT

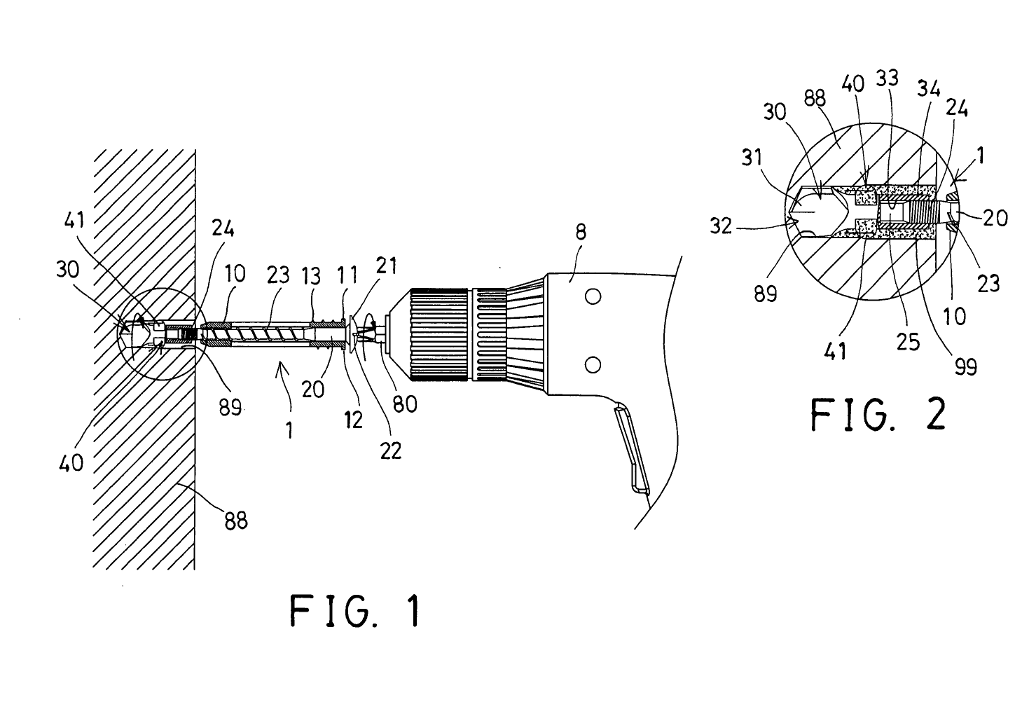

Referring to the drawings, and initially to FIG. 1, a self-drilling wall anchor device 1 in accordance with the present invention is provided for being engaged with a driving tool member or driving shank 80 of a driving tool device 8 and for engaging into a work piece or a wall member 88 made of such as a wood or plastic or synthetic or concrete material, and for securing the wall anchor device 1 to the work pieces 88 or the like, in which the wall member 88 includes a cavity 89 formed therein for receiving a drilling cap or drilling head or a penetrating element 30, and the self-drilling wall anchor device 1 in accordance with the present invention comprises a centering or stabilizing means or device 40 for centering or stabilizing the drilling head or the penetrating element 30 of the wall anchor device 1 and for preventing the drilling head or the penetrating element 30 of the wall anchor device 1 from being tilted relative to the work piece 88.

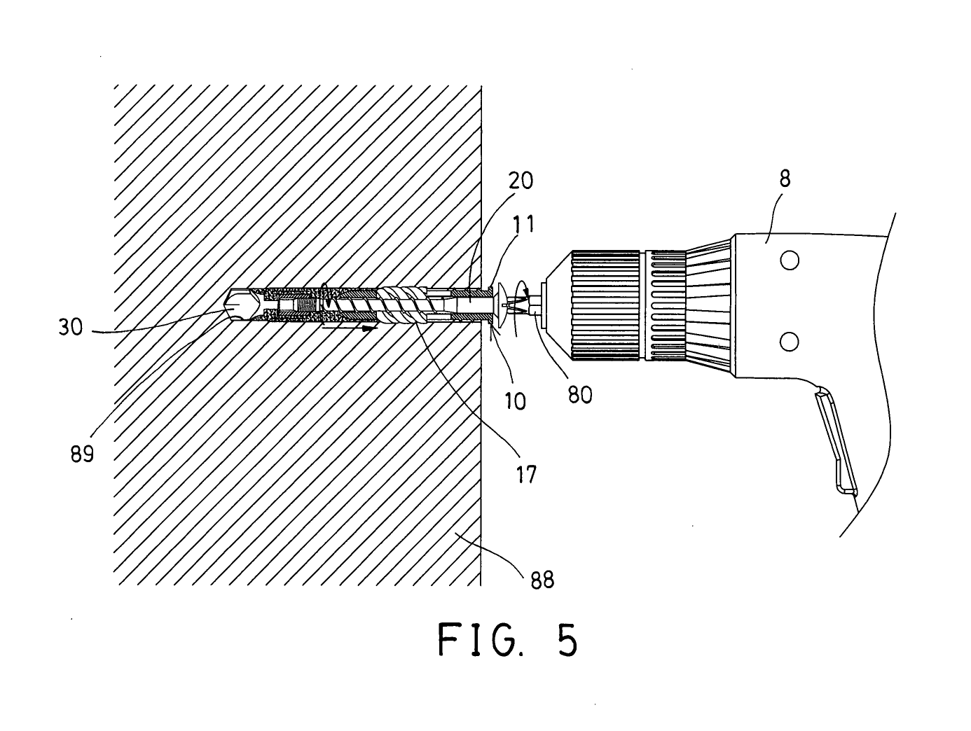

As shown in FIGS. 1-4, the self-drilling wall anchor device 1 in accordance with the present invention comprises an outer anchor sleeve 10 including a peripheral lip 11 extended radially and outwardly from one end or outer end 12 thereof for engaging with or for anchoring the outer anchor sleeve 10 to the work pieces 88 or the like, and including one or more peripheral flanges or a helical flange 13 extended outwardly, for engaging with the work pieces 88 and for allowing the outer anchor sleeve 10 of the self-drilling wall anchor device 1 to be drilled into and solidly secured to the work pieces 88. The outer anchor sleeve 10 includes a bore 14 formed therein, and one or more longitudinal slots 15 formed in a middle portion 16 thereof, and also communicating with the bore 14 thereof, for forming one or more resilient or foldable blades 17 and for allowing the middle portion 16 and the foldable blades 17 of the outer anchor sleeve 10 to be easily bent or expanded than the outer end portion 12 and the inner end portion 18 of the outer anchor sleeve 10.

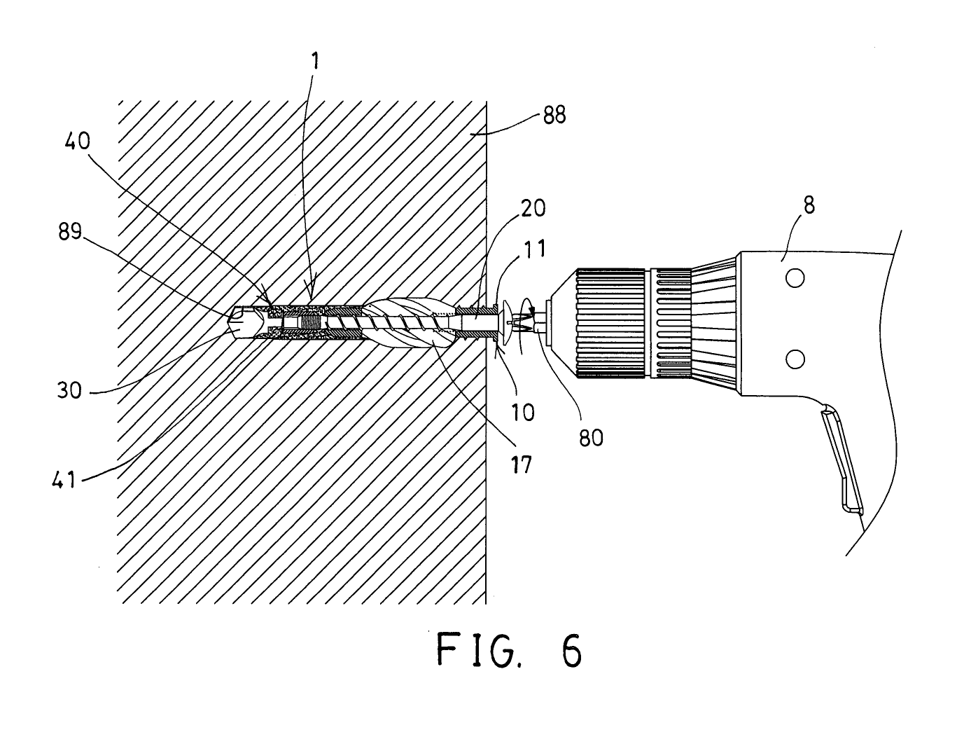

The self-drilling wall anchor device 1 includes an insert 20 engageable into the bore 14 of the outer anchor sleeve 10, and having an enlarged head 21 formed or provided on one end or outer end thereof and having a non-circular engaging hole 22 formed in the enlarged head 21 (FIGS. 1, 4), for receiving the driving shank 80 of the driving tool 8, and for allowing the insert 20 to be rotated or driven by the driving shank 80 of the driving tool 8 or other driving tools (not shown). The insert 20 includes a primary outer thread 23 formed in the middle portion thereof for engaging with the outer anchor sleeve 10, and a secondary outer thread 24 and a non-thread segment 25 formed or provided in the other end or the inner end portion 26 thereof for engaging with the drill head or penetrating element 30 (FIGS. 1-2, 4), and for anchoring or attaching or securing the insert 20 to the penetrating element 30, and thus for allowing the penetrating element 30 to be rotated or driven by the insert 20. The penetrating element 30 may also be solidly secured to the insert 20 by such as welding processes or the like.

The penetrating element 30 includes a drilling portion 31 from one end or inner end 32 thereof for engaging into the cavity 89 of the work piece 88 and for drilling into the work piece 88 (FIGS. 1-2, 5-6), and includes an inner thread 33 formed in the other end or outer end 34 thereof for threading or engaging with the secondary outer thread 24 and thus for allowing the penetrating element 30 to be rotated or driven by the insert 20. The drilling portion 31 of the penetrating element 30 includes an outer diameter equals to or slightly smaller than the inner diameter of the cavity 89 of the work piece 88, and the centering or stabilizing means or device 40 is provided for centering or stabilizing the drilling head or the penetrating element 30 of the wall anchor device 1 and for preventing the drilling head or the penetrating element 30 of the wall anchor device 1 from being tilted relative to the work piece 88.

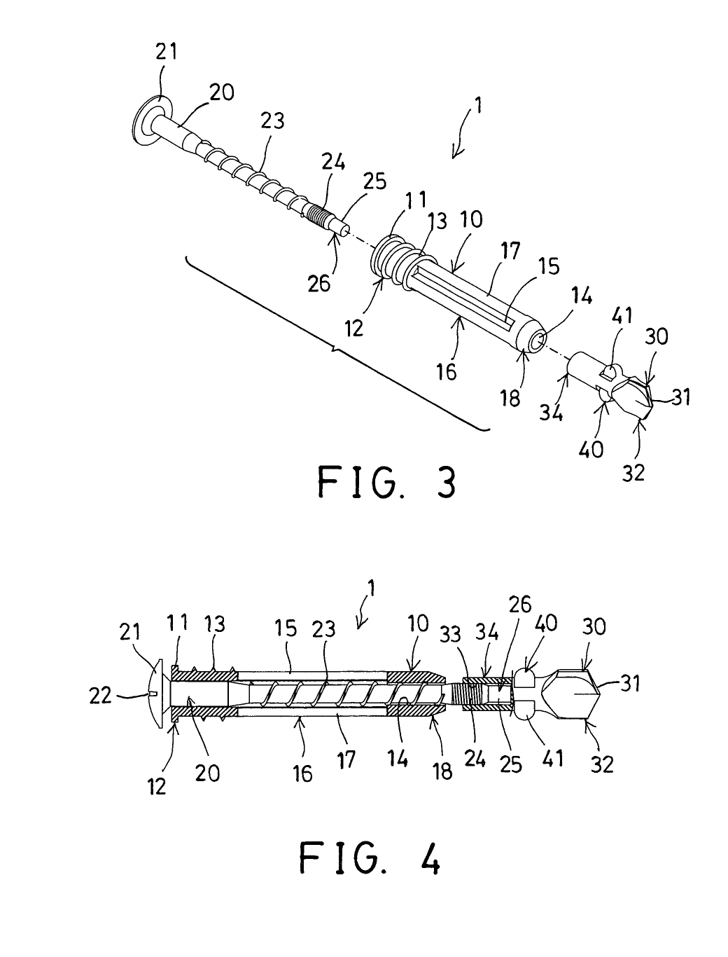

For example, the centering or stabilizing means or device 40 includes one or more (such as two) protruded nibs or projections 41 extended radially and outwardly from the penetrating element 30, and perpendicular to the penetrating element 30 or slightly inclined relative to the penetrating element 30 (FIGS. 1, 2), and an outer diameter of the penetrating element 30 and the projection(s) 41 is equal to or slightly smaller than the inner diameter of the cavity 89 of the work piece 88 for allowing the penetrating element 30 to be suitably centered or stabilized when the penetrating element 30 is engaged into the cavity 89 of the work piece 88 and when the penetrating element 30 is rotated or driven relative to the work piece 88 by the insert 20, and thus for allowing the penetrating element 30 to be guided to suitably drill or engage into the work piece 88.

In operation, as shown in FIGS. 1-2 and 5-6, the penetrating element 30 may first be engaged into the cavity 89 of the work piece 88 and the projection(s) 41 may be engaged with the work piece 88 for centering the penetrating element 30 relative to the work piece 88, and thus for allowing the penetrating element 30 to be guided to suitably and effectively drill or engage into the work piece 88. After the penetrating element 30 is engaged through the work piece 88 or deeply into the work piece 88 by the driving shank 80 of the driving tool 8, the peripheral lip 11 of the outer anchor sleeve 10 may be engaged with or anchored to the work pieces 88 or the like to prevent the outer anchor sleeve 10 from deeply engaged into the work piece 82. When the penetrating element 30 is further rotated or driven by the driving shank 80 of the driving tool 8, the outer anchor sleeve 10 may no longer be engaged into the work pieces 88, and the insert 20 may be forced to rotate relative to the outer anchor sleeve 10, and to expand the thinner or expandable middle portion 16 and the foldable blades 17 of the outer anchor sleeve 10, and to allow the middle portion 16 and the foldable blades 17 of the outer anchor sleeve 10 to be easily bent or expanded relative to the outer and the inner end portions 12, 18 of the outer anchor sleeve 10.

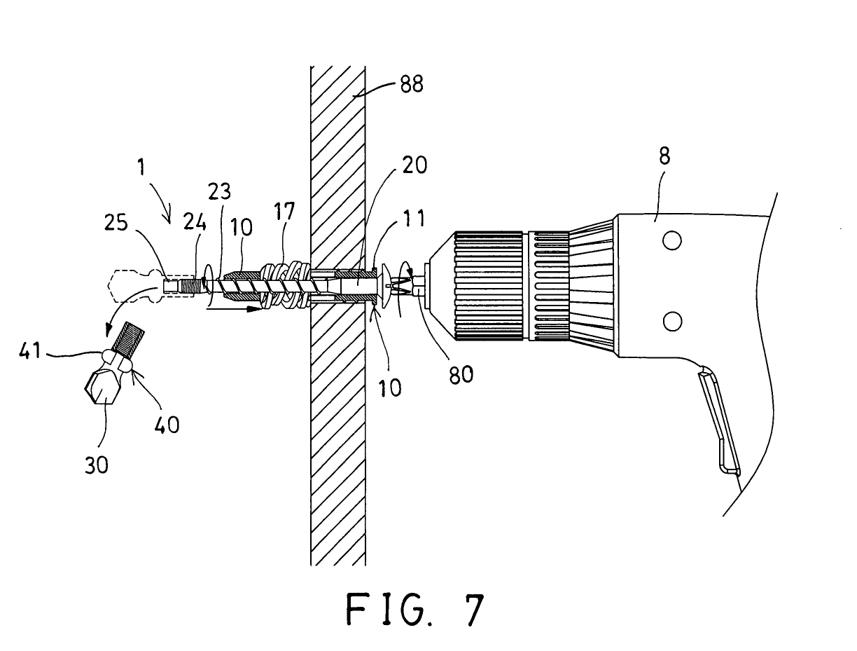

The peripheral flanges or the helical flange 13 of the outer anchor sleeve 10 may further be forced to engage into the work pieces 88 (FIGS. 5, 6; or FIG. 7) to allow the outer anchor sleeve 10 of the self-drilling wall anchor device 1 to be solidly secured to the work pieces 88 or the like and to be prevented from being disengaged from the work pieces 88. In addition, as shown in FIG. 2, the projection(s) 41 of the centering or stabilizing means or device 40 may excavate or remove the drilled materials 99 from or out of the work piece 88 for allowing the middle portion 16 and the foldable blades 17 of the outer anchor sleeve 10 to be easily bent or expanded relative to the outer and the inner end portions 12, 18 of the outer anchor sleeve 10 and to be solidly engaged with the work pieces 88.

Accordingly, the self-drilling wall anchor device in accordance with the present invention includes a centering or stabilizing device for centering or stabilizing the drilling operation of the wall anchor device and for preventing the wall anchor device from being tilted relative to the work piece and for excavating or removing the drilled materials from or out of the work pieces.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A wall anchor device for engaging and anchoring into a work piece which includes a cavity formed therein, said wall anchor device comprising:
an outer anchor sleeve including an outer end portion, an expandable middle portion, and an inner end portion, said outer anchor sleeve including a bore formed therein,
an insert engageable into said bore of said outer anchor sleeve and including an outer end having an engaging hole formed therein for engaging with a tool device, and for allowing said insert to be rotated and driven by the tool device, said insert including an outer thread formed thereon, and including an inner end portion,
a penetrating element attached to said inner end portion of said insert to allow said penetrating element to be rotated and driven by said insert, and
at least one projection extended radially and outwardly from the penetrating element for engaging with the work piece and for centering said penetrating element relative to the work piece and for preventing said penetrating element from being tilted relative to the work piece, and
said penetrating element being rotatable by the tool device with said insert for drilling into the work piece, and for engaging said outer anchor sleeve into the work piece, and said at least one projection of said penetrating element removing a drilled material from the work piece.

2. The wall anchor device as claimed in claim 1, wherein said outer anchor sleeve includes at least one longitudinal slot formed in said middle portion thereof to facilitate bending of said middle portion of said outer anchor sleeve.

3. The wall anchor device as claimed in claim 1, wherein said insert including a secondary outer thread formed thereon, and said penetrating element includes an inner thread formed therein for threading and engaging with said secondary outer thread of said insert.

4. The wall anchor device as claimed in claim 1, wherein said at least one projection is inclined relative to said penetrating element.

5. The wall anchor device as claimed in claim 1, wherein said outer anchor sleeve includes at least one peripheral flange extended outwardly therefrom for engaging with the work piece and for anchoring said outer anchor sleeve to the work piece.

6. The wall anchor device as claimed in claim 5, wherein said at least one peripheral flange of said outer anchor sleeve is a helical flange.

7. The wall anchor device as claimed in claim 1, wherein said outer anchor sleeve includes a peripheral lip extended radially and outwardly from said outer end portion of said outer anchor sleeve for engaging with the work piece.
